(19) United States
(12) Patent Application Publication
(10) Pub. No.: US 2013/0140487 A1
(43) Pub. Date: Jun. 6, 2013

(54) CATHODE MATERIAL USABLE FOR BATTERIES AND METHOD OF MAKING SAME

(71) Applicant: Jen-Chin HUANG, New Taipei City (TW)

(72) Inventor: Jen-Chin HUANG, New Taipei City (TW)

(73) Assignees: GOLDEN CROWN NEW ENERGY (HK) LIMITED, Kowloon (HK); SUZHOU GOLDEN CROWN NEW ENERGY CO., LTD., CHANGSHU CITY (CN)

(21) Appl. No.: 13/361,519

(22) Filed: Jan. 30, 2012

(30) Foreign Application Priority Data
Dec. 2, 2011 (CN) 201110395156.0

(51) Int. Cl. H01M 4/58; C01B 25/26

(52) U.S. Cl. 252/182.1; 423/306

(57) ABSTRACT

A method for preparing a cathode material. In one aspect, the method includes: (1) providing a mixture of at least one iron-containing compound, at least one lithium-containing compound, at least one phosphorus-comprising compound, and at least one oxygen-containing compound, and (2) sintering the mixture, in which the decomposition temperature of the iron-containing compound and the lithium-containing compound is lower than that of the phosphorus-comprising compound and/or the oxygen-containing compound. The cathode material thus prepared, for example, a LiFePO₄ powder, has a purity ranging from about 90% to about 95% by weight, and a gram specific capacity ranging from about 150 to about 170 mAh/g.

### CROSS-REFERENCE TO RELATED APPLICATIONS

This application claims priority to and the benefit of, pursuant to 35 U.S.C. §119(a), Chinese patent application No. 201110395156.0, filed Dec. 2, 2011, entitled “CATHODE MATERIAL USABLE FOR BATTERIES AND METHOD OF MAKING SAME”, by Jen-Chin Huang, the content of which is incorporated herein by reference in its entirety.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates generally to a cathode material for batteries, and more particularly, to a cathode material, i.e., lithium iron phosphate (LiFePO₄), for lithium ion batteries used in power tools, consumer electronics, and electric vehicles, and a method for preparing the cathode material.

### BACKGROUND OF THE INVENTION

A lithium ion battery is a rechargeable battery in which lithium ions (Li⁺) can be intercalated in and deintercalated from positive electrode (cathode) and negative electrode (anode) materials. A cathode thereof is generally formed by a lithium intercalated compound, for example, lithium cobalt oxide (LiCoO₂) having a layered crystal structure, lithium nickel oxide (LiNiO₂), and lithium manganese oxide (LiMn₂O₄) having a crystal structure of spinel. During charging, Li⁺ is deintercalated from the cathode, passes through an electrolyte, and is then intercalated in a cathode. At the same time, electrons are supplied from an external circuit to the cathode for charge compensation. In contrast, during discharging, Li⁺ is deintercalated from the cathode, passes through the electrolyte, and is then intercalated in the cathode material.

In 1996, a cathode material having a crystal structure of olivine was discovered, and in 1997, John B. Goodenough et al. from University of Texas (US) patented a material having a crystal structure of olivine and a chemical formula of LiFePO₄, in which the crystal structure of olivine has the property of intercalation and deintercalation (U.S. Pat. No. 5,910,382).

In the LiFePO₄ cathode material prepared through a conventional process, impurities such as ferric phosphate, lithium phosphate, ferric oxide, lithium oxide, ferric carbonate, lithium carbonate are generated. As a result, though a gram specific capacity of the LiFePO₄ powder is theoretically 180 mAh/g, the specific capacity of the product from the conventional process is practically only in the range of 90 to 110 mAh/g. It would gain a great deal of industrial relevance if a process for preparing LiFePO₄, with improvements of the purity thereof, thereby improving the gram specific capacity of the LiFePO₄ powder, would be available.

Therefore, a heretofore unaddressed need exists in the art to address the aforementioned deficiencies and inadequacies.

### SUMMARY OF THE INVENTION

In one aspect, the present invention is directed to a LiFePO₄ cathode material for batteries, in which the content percentage of LiFePO₄ in the LiFePO₄ cathode material is about 90%-99% by weight. Preferably, the content percentage of LiFePO₄ in the LiFePO₄ cathode material is 90%-95% by weight.

In another aspect, the present invention is directed to a LiFePO₄ cathode material for batteries, in which the gram specific capacity of the LiFePO₄ cathode material is about 145-170 mAh/g. Preferably, the gram specific capacity of the LiFePO₄ cathode material is about 160-165 mAh/g.

In a yet another aspect, the present invention is directed to a method for preparing LiFePO₄. In one embodiment, the method includes: (1) providing a mixture of at least one iron-containing compound, at least one lithium-containing compound, at least one phosphorus-comprising compound, and at least one oxygen-containing compound, and (2) sintering the mixture of the compounds, in which the decomposition temperature of the iron-containing compound and the lithium-containing compound is lower than that of the phosphorus-comprising compound.

In a preferred embodiment, the iron-containing compound and the lithium-containing compound are first sintered for decomposition under vacuum. That is, the iron-containing compound and the lithium-containing compound are substantially decomposed to extract elements iron and lithium, while the phosphorus-comprising compound or/and the oxygen-containing compound are substantially not decomposed. Preferably, after the step of first sintering for partial decomposition, the products are second sintered for complete reaction, so that the products are completely reacted. More preferably, after the second sintering for complete reaction, a third sintering for crystallization is performed, to crystallize a product. Alternatively, the second sintering for complete reaction and the third sintering for crystallization may be done in one step, or in two steps.

“Substantially” as used herein means that at least 65%, for example, at least 70%, 75%, 80%, 85%, 90%, 95%, 99% or 100%, of a compound is decomposed or not decomposed. For example, at least 65% of the iron-containing compound and the lithium-containing compound are decomposed at a low temperature (380° C.), while at least 65% of the phosphorus-comprising compound or/and the oxygen-containing compound are not decomposed at the same temperature.

In another preferred embodiment, the first sintering temperature for partial decomposition is about 150-400° C., and the first sintering time is about 2-8 hours, for example, 0.5-15 hours, 1-12 hours, 2-8 hours, or 3-6 hours. The temperature may be greater than or equal to 150° C., and lower than or equal to about 400° C. “About” as used herein may be that the variation is within ±5%, ±2.5%, ±10%, or ±15%. Preferably, the first sintering for decomposition is carried out under vacuum.

In a further embodiment, the second sintering for complete reaction or/and crystallization is carried out in a reductive (hydrogen) or inert (nitrogen or argon) atmosphere at a temperature of 450° C.-1200° C. for 1-24 hours. Preferably, the second sintering temperature for complete reaction or/and crystallization is 600° C. to 1200° C., and the second sintering time is 4-24 hours. More preferably, the crystallized product may be milled into a powder, and sieved, so that the particle size and particle size distribution are uniform.

The step of first sintering for partial decomposition, among other things, can remove moisture or other liquid and gaseous impurities in the raw materials, and avoid oxidation (for example, removal of oxalic acid and carbonic acid while phosphoric acid is kept). Through the sintering for complete reaction or/and crystallization, the raw materials are reacted, the wastes (e.g. ammonia, and carbon dioxide) generated in reaction are removed, and the product is crystallized.

The LiFePO₄ powder thus prepared has a purity ranging from 90% to 95% by weight, the proportion of the incompletely reacted lithium phosphate, ferric phosphate, lithium oxide, ferric oxide, lithium carbonate, and ferric carbonate therein is below 15% by weight, and the gram specific capacity is in the range of 150 to 170 mAh/g.

In another embodiment, the molar ratio of elements iron, lithium, phosphorus, and oxygen in the mixture before sintering is 1:1:1:4.

In another embodiment, the iron-containing compound, and the lithium-containing compound include an oxalate (C₂O₄²⁻) compound or a carbonate (CO₃²⁻) compound. For example, the iron-containing compound (used as iron (II) source) is selected from the group consisting of ferrous oxalate (Fe₂C₂O₄), ferric oxide (Fe₂O₃), ferrous oxalate hydrate (Fe₂C₂O₄.2H₂O), and combination thereof. The phosphorus-comprising compound is selected from the group consisting of aminophosphate (NH₂PO₄), ammonium dihydrogen phosphate (NH₄H₂PO₄) and combination thereof. For example, raw materials including an oxalate compound as the iron (II) source (e.g. Fe₂C₂O₄), a carbonate compound as the lithium source (e.g. Li₂CO₃), and a compound as the phosphorus source (e.g. aminophosphate (NH₂PO₄)) are reacted, to prepare lithium iron phosphate (LiFePO₄).

The LiFePO₄ powder prepared by using the method of the present invention has a purity ranging from 90% to 95% by weight, the proportion of the incompletely reacted lithium phosphate, ferric phosphate, lithium oxide, ferric oxide, lithium carbonate, and ferric carbonate therein is below 15% by weight, and the gram specific capacity is in the range of about 150 to 170 mAh/g.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a flow chart of a method for preparing a cathode material (lithium iron phosphate) according to one embodiment of the present invention; and

FIG. 2 is a flow chart of a method for preparing a cathode material (lithium iron phosphate) according to one embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

The specific embodiments of the present invention are described below with reference to examples. However, the exemplary descriptions are provided only for illustrating the implementation of the present invention, and are not intended to limit the claims of the present invention.

The embodiments of the present invention described below include particles and nano particles, and the size of the particles are generally indicated by the average particle size distribution of Dₙ, where n is a percentage number between 0 and 100. Specifically, the average particle size distribution of Dₙ is defined as the cumulative undersize distribution of the relative amount of the particles at or below a particular size. For example, “particles having an average particle size distribution of D₅₀ of 500 nm” means that 50% of the amount of the particles have the size at or below 500 nanometers.

### Example 1

### Preparation Method with Addition of Magnesium Carbonate and Sintering in Absence of Vacuum

1.1 Raw materials:

1.1.1 Aminophosphate (NH₂PO₄), 39.8 g,

1.1.2 Ferrous oxalate (FeC₂O₄), 97.5 g,

1.1.3 Lithium carbonate (Li₂CO₃), 8.0 g, and

1.1.4 Magnesium carbonate (MgCO₃), 0.4 g.

1.2 Preparation method: an embodiment with addition of an intermediate destroyer (as shown in FIG. 2).

1.2.1 First mixing step: aminophosphate, ferrous oxalate, lithium carbonate, and magnesium carbonate described in Section 1.1 were mixed, and milled to form a powder with uniform particle size.

1.2.2 First sintering step: the raw materials obtained in Step 1.2.1 were heated at 250° C. for 2 hours under the protection of nitrogen, and the liquid and gaseous impurities generated in the sintering process were separated by refreshing nitrogen every 30 minutes.

1.2.3 Second sintering step: the product obtained in Step 1.2.2 was sintered at 500° C. for 2 hours under the protection of nitrogen, and the generated carbon dioxide (CO₂), ammonia (NH₃), and oxygen (O₂) were separated.

1.2.4 Third sintering step: the product obtained in Step 1.2.3 was sintered at 800° C. for 5 hours under the protection of nitrogen.

1.2.5 Grinding and sieving step: the material was milled and sieved to obtain a LiMg_{y}FePO₄ powder having a final particle size of about 1 to 10 μm, in which y is approximately equal to 0.5%.

1.3 Product: through the preparation method with addition of magnesium carbonate, and sintering in absence of vacuum, a powder having a chemical formula LiMg_{y}FePO₄ where y=0.5% was obtained, in which the gram specific capacity of the powder was about 135 mAh/g, and the average particle size distribution of D₉₇ was about 9 μm.

### Example 2

### Preparation Method without Addition of Magnesium Carbonate, and with Sintering Under Vacuum

2.1 Raw materials:

2.1.1 Aminophosphate (NH₂PO₄), 39.8 g,

2.1.2 Ferrous oxalate (FeC₂O₄), 97.5 g, and

2.1.3 Lithium carbonate (Li₂CO₃), 8.0 g.

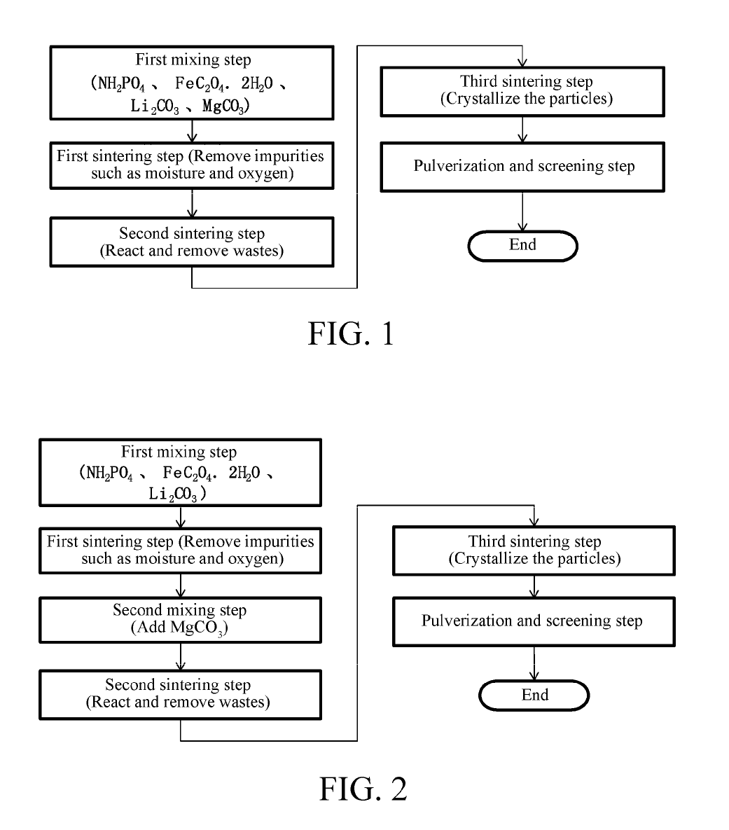

2.2 Preparation method: an embodiment with sintering under vacuum (as shown in FIG. 1).

2.2.1 First mixing step: aminophosphate, ferrous oxalate, and lithium carbonate described in Section 2.1 were mixed and milled to form a powder with uniform particle size.

2.2.2 First sintering step: the raw materials obtained in Step 2.2.1 were heated at 250° C. for 2 hours in a vacuum environment, the liquid and gaseous impurities generated in the sintering process were separated, and oxalic acid and carbonic acid were removed, while phosphoric acid was kept.

2.2.3 Second sintering step: the product obtained in Step 2.2.2 was sintered at 500° C. for 2 hours in a vacuum environment, and the generated carbon dioxide (CO₂), ammonia (NH₃), and oxygen (O₂) were separated.

2.2.4 Third sintering step: the product obtained in Step 2.2.3 was sintered at 800° C. for 5 hours under the protection of nitrogen.

2.2.5 Grinding and sieving step: the material was milled and sieved to obtain a LiFePO₄ powder having a final particle size of about 1 to 10 μm.

2.3 Product: through the preparation method with no addition of magnesium carbonate, and with sintering under vacuum, a powder having a chemical formula LiFePO₄ was obtained, in which the gram specific capacity of the powder was about 150 mAh/g, and the average particle size distribution of D₉₇ was about 25 μm.

### Example 3

### Preparation Method with Addition of Magnesium Carbonate and Sintering in Absence of Vacuum

3.1 Raw materials:

3.1.1 Aminophosphate (NH₂PO₄), 39.8 g,

3.1.2 Ferrous oxalate (FeC₂O₄), 97.5 g,

3.1.3 Lithium carbonate (Li₂CO₃), 8.0 g, and

3.1.4 Magnesium carbonate (MgCO₃), 0.5 g.

3.2 Preparation method: an embodiment with addition of an intermediate destroyer (as shown in FIG. 2).

3.2.1 First mixing step: aminophosphate, ferrous oxalate, and lithium carbonate described in Section 3.1 were mixed, and milled to form a powder with uniform particle size.

3.2.2 First sintering step: the raw materials obtained in Step 3.2.1 were heated at 300° C. for 2 hours under the protection of nitrogen, and the liquid and gaseous impurities generated in the sintering process were separated by refreshing nitrogen every 30 minutes.

3.2.3 Second mixing step: the product obtained in Step 3.2.2 was mixed with magnesium carbonate, and milled into a uniform power mixture.

3.2.4 Second sintering step: the product obtained in Step 3.2.3 was sintered at 550° C. for 2 hours under the protection of nitrogen, and the generated carbon dioxide (CO₂), ammonia (NH₃), and oxygen (O₂) were separated.

3.2.5 Third sintering step: the product obtained in Step 3.2.4 was sintered at 800° C. for 3 hours under the protection of nitrogen.

3.2.6 Grinding and sieving step: the material was milled and sieved to obtain a LiMg_{y}FePO₄ powder having a final particle size of about 1 to 10 μm, in which y is approximately equal to 0.8%.

3.3 Product: through the preparation method with addition of magnesium carbonate, and sintering in absence of vacuum, a powder having a chemical formula LiMg_{y}FePO₄ where y=0.8% was obtained, in which the gram specific capacity of the power was about 130 mAh/g, and the average particle size distribution of D₉₇ was about 8 μm.

### Example 4

### Preparation Method with No Addition of Magnesium Carbonate, and with Sintering Under Vacuum

4.1 Raw materials:

4.1.1 Aminophosphate(NH₂PO₄), 39.8 g,

4.1.2 Ferrous oxalate (FeC₂O₄), 97.5 g, and

4.1.3 Lithium carbonate (Li₂CO₃), 8.0 g.

4.2 Preparation method: an embodiment with sintering under vacuum (as shown in FIG. 1).

4.2.1 First mixing step: aminophosphate, ferrous oxalate, and lithium carbonate described in Section 4.1 were mixed and milled to form a powder with uniform particle size.

4.2.2 First sintering step: the raw materials obtained in Step 4.2.1 were heated at 300° C. for 2 hours in a vacuum environment, and the liquid and gaseous impurities generated in the sintering process were separated and discharged.

4.2.3 Second sintering step: the product obtained in Step 4.2.2 was sintered at 500° C. for 4 hours in a vacuum environment, and the generated carbon dioxide (CO₂), ammonia (NH₃), and oxygen (O₂) were separated.

4.2.4 Third sintering step: the product obtained in Step 4.2.3 was sintered at 700° C. for 10 hours under the protection of nitrogen.

4.2.5 Grinding and sieving step: the material was milled and sieved to obtain a LiFePO₄ powder having a final particle size of about 1 to 5 μm.

4.3 Product: through the preparation method with no addition of magnesium carbonate, and with sintering under vacuum, a powder having a chemical formula LiFePO₄ was obtained, in which the gram specific capacity of the powder was about 159 mAh/g, and the average particle size distribution of D₉₇ was about 20 μm.

### Example 5

### Preparation Method with Addition of Magnesium Carbonate and Sintering in Absence of Vacuum

5.1 Raw materials:

5.1.1 Aminophosphate (NH₂PO₄), 39.8 g,

5.1.2 Ferrous oxalate (FeC₂O₄), 97.5 g,

5.1.3 Lithium carbonate (Li₂CO₃), 8.0 g, and

5.1.4 Magnesium carbonate (MgCO₃), 0.4 g.

5.2 Preparation method—an embodiment with addition of an intermediate destroyer (as shown in FIG. 2).

5.2.1 First mixing step: aminophosphate, ferrous oxalate, and lithium carbonate described in Section 5.1 were mixed, and milled to form a powder with uniform particle size.

5.2.2 First sintering step: the raw materials obtained in Step 5.2.1 were heated at 350° C. for 1 hours under the protection of nitrogen, and the liquid and gaseous impurities generated in the sintering process were separated and discharged by refreshing nitrogen every 30 minutes.

5.2.3 Second mixing step: the product obtained in Step 5.2.2 was mixed with magnesium carbonate, and milled to form a powder with uniform particle size.

5.2.4 Second sintering step: the product obtained in Step 5.2.3 was sintered at 550° C. for 2 hours under the protection of nitrogen, and the generated carbon dioxide (CO₂), ammonia (NH₃), and oxygen (O₂) were separated.

5.2.5 Third sintering step: the product obtained in Step 5.2.4 was sintered at 750° C. for 3 hours under the protection of nitrogen.

5.2.6 Grinding and sieving step: the material was milled and sieved to obtain a LiMg_{y}FePO₄ powder having a final particle size of about 1 to 10 μm, in which y is approximately equal to 0.3%.

5.3 Product: through the preparation method with addition of magnesium carbonate, and sintering in absence of vacuum, a powder having a chemical formula LiMg_{y}FePO₄ where y=0.6% was obtained, in which the gram specific capacity of the powder was about 135 mAh/g, and the average particle size distribution of D₉₇ was about 10 μm.

### Example 6

### Preparation Method with No Addition of Magnesium Carbonate, and with Sintering Under Vacuum

6.1 Raw materials:

6.1.1 Aminophosphate (NH₂PO₄), 39.8 g,

6.1.2 Ferrous oxalate (FeC₂O₄), 97.5 g, and

6.1.3 Lithium carbonate (Li₂CO₃), 8.0 g.

6.2 Preparation method: an embodiment with sintering under vacuum (as shown in FIG. 1).

6.2.1 First mixing step: aminophosphate, ferrous oxalate, and lithium carbonate described in Section 6.1 were mixed and milled to form a powder with uniform particle size.

6.2.2 First sintering step: the raw materials obtained in Step 6.2.1 were heated at 350° C. for 2 hours in a vacuum environment, and the liquid and gaseous impurities generated in the sintering process were separated and discharged.

6.2.3 Second sintering step: the product obtained in Step 6.2.2 was sintered at 550° C. for 4 hours under the protection of nitrogen, and the generated carbon dioxide (CO₂), ammonia (NH₃), and oxygen (O₂) were separated.

6.2.4 Third sintering step: the product obtained in Step 6.2.3 was sintered at 800° C. for 10 hours under the protection of nitrogen.

6.2.5 Grinding and sieving step: the material was milled and sieved to obtain a LiFePO₄ powder having a final particle size of about 1 to 10 μm.

6.3 Product: through the preparation method with no addition of magnesium carbonate, and with sintering under vacuum, a powder having a chemical formula LiFePO₄ was obtained, in which the gram specific capacity of the powder was about 164 mAh/g, and the average particle size distribution of D₉₇ was about 31 μm.

### Example 7

### Preparation Method with Addition of Magnesium Carbonate and Sintering Under Vacuum

7.1 Raw materials:

7.1.1 Aminophosphate (NH₂PO₄), 39.8 g

7.1.2 Ferrous oxalate (FeC₂O₄), 97.5 g

7.1.3 Lithium carbonate (Li₂CO₃), 8.0 g

7.1.4 Magnesium carbonate (MgCO₃), 0.5 g

7.2 Preparation method—an embodiment with sintering under vacuum.

7.2.1 First mixing step: aminophosphate, ferrous oxalate, lithium carbonate, and magnesium carbonate described in Section 7.1 were mixed, and milled to form a powder with uniform particle size.

7.2.2 First sintering step: the raw materials obtained in Step 7.2.1 were heated at 300° C. for 2 hours in a vacuum environment, and the liquid and gaseous impurities generated in the sintering process were separated and discharged.

7.2.3 Second sintering step: the product obtained in Step 7.2.2 was sintered at 500° C. for 4 hours in a vacuum environment, and the generated carbon dioxide (CO₂), ammonia (NH₃), and oxygen (O₂) were separated.

7.2.4 Third sintering step: the product obtained in Step 7.2.3 was sintered at 700° C. for 10 hours under the protection of nitrogen.

7.2.5 Grinding and sieving step: the material was milled and sieved to obtain a LiMg_{y}FePO₄ powder having a final particle size of about 1 to 10 μm, in which y is approximately equal to 0.5%.

7.3 Product: through the preparation method with addition of magnesium carbonate, and sintering under vacuum, a powder having a chemical formula LiMg_{y}FePO₄ where y=0.5% was obtained, in which the gram specific capacity of the powder was about 160 mAh/g, and the average particle size distribution of D₉₇ was about 8 μm.

### Comparative Example 1

In the comparative example, a method for preparing lithium iron phosphate as a positive active (cathode) material in the related art was described.

1.1 Raw materials:

1.1.1 Aminophosphate (NH₂PO₄), 39.8 g,

1.1.2 Ferrous oxalate (FeC₂O₄), 97.5 g, and

1.1.3 Lithium carbonate (Li2CO₃), 8.0 g.

1.2.1A mixture formed by the three raw materials in Section 1.1 was sintered once at 800° C. for 10 hours under the protection of nitrogen.

1.2.2 The material obtained from step 1.2.1 was milled and sieved to obtain a LiFePO₄ powder having a final particle size of about 1 to 10 μm, in which the average particle size distribution of D₉₇ of the powder was about 50 μm, and the gram specific capacity was about 115 μm/h.

### Comparative Example 2

2.1 8.0 g of lithium carbonate (Li₂CO₃), 97.5 g of ferrous oxalate (FeC₂O₄), 39.8 g of aminophosphate (NH₂PO₄), and 0.4 g of magnesium carbonate (LiCO₃) were mixed.

2.2 The mixture in Step 2.1 was sintered once at 800° C. for 10 hours under the protection of nitrogen.

2.3 The material obtained from step 2.2 was milled and sieved to obtain a LiMg_{y}FePO₄ powder having a final particle size of about 1 to 10 μm, in which y is approximately equal to 5%, the average particle size distribution of D₉₇ of the powder was about 40 μm, and the gram specific capacity was about 115 μm/h.

### Experimental Example

### Preparation of Batteries by Using the Materials Prepared in Examples 1-7 and Comparative Examples 1 And 2

3.1 Preparation of cathode:

3.1.1 90 g of the lithium iron phosphate powder prepared in Examples 1-7 and Comparative Examples 1 and 2, 5 g of a binder polyvinylidene fluoride (PVDF), and 5 g of a conductive agent carbon black were added into 50 g of N-methyl-pyrrolidone (NMP), and agitated in a vacuum agitator, to form a uniform cathode slurry.

3.1.2 The cathode slurry was uniformly applied onto two sides of an aluminum foil having an thickness of 20 μm, then dried at 150° C., rolled, and cut to obtain a cathode having a size of 140×65 mm, in which the cathode contained about 5.3 g of the lithium iron phosphate powder as the active ingredient.

3.2 Preparation of cathode:

3.2.1 90 g of a cathode active ingredient natural graphite, 5 g of a binder polyvinylidene fluoride (PVDF), and 5 g of a conductive agent carbon black were added into 100 g of N-methyl-pyrrolidone (NMP), and agitated in a vacuum agitator to form a uniform cathode slurry.

3.2.2 The cathode slurry was uniformly applied onto two sides of a copper foil having an thickness of 20 μm, then dried at 90° C., rolled, and cut to obtain a cathode having a size of 140×65 mm, in which the cathode contained about 3.8 g of natural graphite as the active ingredient.

3.3 Assembly of battery:

3.3.1 The cathode, the cathode, and a laminated polypropylene film were respectively fabricated into an electrode core of a prismatic lithium ion battery.

3.3.2 LiF₆ was dissolved in a mixed solution of EC/EMC/DEC=1:1:1 at a concentration of 1 mol/L, to form a non-aqueous electrolyte.

3.3.3 The electrolyte was injected in an amount of 3.8 g/Ah into an aluminum casing of a battery and sealed, and lithium ion secondary batteries A1, A2, A3, A4, A5, A6, and A7 according to the Examples of the present invention and lithium ion secondary batteries AC1, and AC2 according to the comparative Examples were respectively fabricated.

4. Test of battery performance:

4.1 The lithium ion secondary batteries A1, A2, A3, A4, A5, A6, A7, AC1, and AC2 fabricated in Section 3.3.2 were respectively positioned on a test cabinet, charged up to an upper limit of 3.75 V at a constant current of 0.2 C, stood for 20 minutes, and then discharged from 3.45 V to 2.0 V at a current of 0.2 C, and the first discharge capacity of the battery was recorded.

4.2 A mass specific capacity of the battery is calculated by a formula below: Mass specific capacity=First discharge capacity of a battery (mAh)/Weight of a cathode material (g).

4.3 The results are as shown in Table 1.

TABLE 1
Test data of battery performance

| Example or | | First discharge | Mass specific |
|---|---|---|---|
| Comparative | Battery | capacity of | capacity |
| example | No. | battery (mAh) | (mAh/g) |
| Example 1 | A1 | 716 | 135 |
| Example 2 | A2 | 795 | 150 |
| Example 3 | A3 | 689 | 130 |
| Example 4 | A4 | 843 | 159 |
| Example 5 | A5 | 716 | 135 |
| Example 6 | A6 | 869 | 164 |
| Example 7 | A7 | 848 | 160 |
| Comparative | AC1 | 610 | 115 |
| Example 1 | | | |
| Comparative | AC1 | 610 | 115 |
| Example 2 | | | |

It can be seen from the data in Table 1 that, among other things, the first discharge capacity and the mass specific capacity of the batteries AC1 and AC2 fabricated with lithium iron phosphate prepared in comparative examples are undesirable, while the first discharge capacity and the mass specific capacity of the batteries A1, A2, A3, A4, A5, A6, and A7 fabricated with lithium iron phosphate prepared in examples of the present invention are obviously improved.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for preparing lithium iron phosphate, comprising:
(1) providing a mixture of at least one iron-containing compound, at least one lithium-containing compound, at least one phosphorous-comprising compound, and at least one oxygen-containing compound; and
(2) sintering the mixture;
wherein a decomposition temperature of the iron-containing compound and the lithium-containing compound are lower than that of the phosphorous-comprising compound and the oxygen-containing compound.

2. The method according to claim 1, wherein the iron-containing compound and the lithium-containing compound are sintered in a vacuum environment.

3. The method according to claim 2, wherein a first sintering temperature in the vacuum environment is about 150-400° C., and a first sintering time is about 1-12 hours.

4. The method according to claim 3, wherein products obtained after sintering in the vacuum environment are further sintered for about 1-24 hours for complete reaction and/or crystallization in a reductive or inert atmosphere at a second temperature of about 450° C.-1200° C.

5. The method according to claim 4, wherein a third sintering temperature for complete reaction and/or crystallization is about 600° C.-1200° C., and a third sintering time is about 4-24 hours.

6. The method according to claim 1, wherein the iron-containing compound and the lithium-containing compound are selected from the group consisting of an oxalate (C₂O₄²⁻) compound, a carbonate (CO₃²⁻) compound, and combination thereof.

7. The method according to claim 1, wherein the iron-containing compound is selected from the group consisting of ferrous oxalate (Fe₂C₂O₄), ferrous oxalate hydrate (Fe₂C₂O₄.2H₂O), ferric carbonate, ferrous carbonate, ferric oxide (Fe₂O₃), and combination thereof, and the lithium-containing compound is selected from the group consisting of lithium oxalate, lithium carbonate, and combination thereof.

8. The method according to claim 1, wherein the phosphorus-comprising compound is selected from the group consisting of aminophosphate (NH₂PO₄), ammonium dihydrogen phosphate (NH₄H₂PO₄), and combination thereof.

9. The method according to claim 1, wherein a molar ratio of elements iron, lithium, phosphorus, and oxygen in the mixture is about 1:1:1:4.

10. The method according to claim 1, wherein element magnesium is added to the mixture before or during the process of sintering.

11. The method according to claim 10, wherein the molar percentage of element magnesium added to the mixture is about 0.2%-5%.

12. A LiFePO₄ cathode material, wherein a content of LiFePO₄ by weight is about 90%-99%.

13. The material according to claim 12, wherein the content of LiFePO₄ by weight is about 90%-95%.

14. A LiFePO₄ cathode material having a gram specific capacity of about 145-170 mAh/g.

15. The LiFePO₄ cathode material according to claim 14, wherein the gram specific capacity of the LiFePO₄ cathode material is about 150-165 mAh/g.
